(19) United States
(12) Patent Application Publication
(10) Pub. No.: US 2014/0069771 A1
(43) Pub. Date: Mar. 13, 2014

(54) DUO SPIRAL ESCALATOR WITH DIRECT RETURN

(71) Applicants: JOHN RICHARD STRIETER, Rock Island, IL (US); David R. Renneke, Rock Island, IL (US); Joshua M. Dyer, Silvis, IL (US)

(72) Inventors: JOHN RICHARD STRIETER, Rock Island, IL (US); David R. Renneke, Rock Island, IL (US); Joshua M. Dyer, Silvis, IL (US)

(21) Appl. No.: 13/610,064

(22) Filed: Sep. 11, 2012

(51) Int. Cl. B66B 21/06

(52) U.S. Cl. 198/328

(57) ABSTRACT

This invention describes the design of a carrier system for people or goods permitting the continuous path of travel of a duo spiral escalator ascending and descending around a tower with a fixed diameter from the top to the bottom. At the bottom level and at the top level of the duo spiral escalator the invention consists of discontinuous upper and lower tracks for reversing the tread direction. Escalator chains connected to the tread support rods insure a smooth transfer of the treads between sets of tracks. This invention permits continuous transportation of the riders ascending and descending to a plurality of floors of varying ceiling heights. Current straight and spiral escalators have half of the treads carrying riders while the other half are empty as they travel back underneath. With this invention, as the treads move between floors, all of them may have riders aboard. This design saves horizontal space and requires fewer treads and materials than current escalators.

### CROSS-REFERENCE TO A RELATED APPLICATION

On Sep. 5, 2012 inventor John Richard Strieter applied for a patent titled Duo Spiral Escalator with Curved Return. The application Ser. No. 13/603820. The Curved Return invention differs from the Direct Return invention in that the treads follow a curved path as they proceed from ascending to descending at the top floor of the spiral escalator. For the Curved Return invention, in the hidden transition space the treads follow two half circle paths connected together thereby achieving a change of 180 degrees in one direction followed by 180 degrees in the other direction.

The Curved Return invention specifies that the treads follow this same type of curved path as they proceed from descending to ascending in the hidden transition space at the bottom floor.

There is another difference between the two inventions. In the Curved Return invention the treads must morph their trapezoidal shape at the top and bottom floors such that the long and short ends effectively change places. In the Direct Return invention, all the treads retain their original trapezoidal shape and each tread may have a fixed riser attached to it. This riser is positioned on the trailing edge of the tread when the escalator steps are ascending. It is on the leading edge when the steps are descending.

### BACKGROUND OF THE INVENTION

For many centuries spiral stairs have been a fascination for architects, designers, builders and owners. Even more fascination occurred when the spiral design encompassed single supports either on the exterior wall or on an interior column. As strength of materials improved, construction designs provided for supports at the base and the floor above. The greater the ceiling height the more complex and spectacular the designs became.

Compared with elevators, straight line escalators serving one floor at a time in both directions became an improvement in passenger movement where less than a dozen floors were involved.

Next came the transition from straight to curved and even spiral escalators. The preference for spiral escalators became popular since the design requires less horizontal space than straight escalators. A spiral escalator was constructed at London's Holloway Road underground station in 1906 only to be dismantled almost immediately. The Mitsubishi Electric Corporation has developed successful commercial designs and has manufactured curved and spiral escalators since the 1980s.

All of the designs are limited to serve only one pair of floors at a time. Separate escalators are required for ascending or descending installations and are usually constructed side by side, requiring a large horizontal space. Only half of the stair treads are in use at any time for all escalators, due to the continuous travel requiring the returning treads passing under the conveyor. This results in materials in use only half of the time.

Ever since 1883 when the first escalator (called “inclined elevator”) was invented, the escalator has been a favorite means for mass transportation of passengers in preference to vertical elevators. Through the years many inventions have been processed that attempted to improve the straight line escalators by: making more efficient use of the horizontal space required, serving multiple floors without requiring the passengers to leave and re-enter at each floor, using all steps all of the time, utilizing large vertical space, improving the aesthetics and architecture, and increasing passenger movement more economically and efficiently. This invention provides the design of a spiral escalator that achieves all of these aspirations.

### BRIEF SUMMARY OF THE INVENTION

This invention consists of the design of a continuous path of travel for a duo spiral escalator ascending and descending around a tower with a fixed diameter from top to bottom. The treads have four wheels and are pulled along tracks by means of chains connected to the center support rod of each tread. All of the treads are connected together and move simultaneously on multiple floors. As the treads move between floors, all of them may have riders aboard in contrast with current escalators, straight and spiral, wherein half of the treads are empty as they travel back underneath.

At the top level of the duo spiral escalator the treads, tracks and chains follow a horizontal circular path as the riders step off when they arrive at the top floor. The treads then disappear behind a wall, gradually ascend to the ceiling, and circle halfway around the tower. The chains then pull the treads off of their tracks located near the ceiling, lower them directly from the ceiling to the floor, place them on the lower set of tracks, pull them out from below another wall, and move them horizontally on the opposite side of the escalator tower, ready for riders to step on before descending.

At the bottom level of the duo spiral escalator, after the riders step off at the bottom floor, the tracks follow a path that lowers the treads a short distance below the floor. After traveling halfway around the circumference at the base of the escalator tower, the chains pull the treads off of their tracks, raise them through the floor, place them on another set of tracks, and reverse their direction of motion so that they move horizontally on the opposite side of the escalator tower, ready for riders to step on before ascending.

The forward motion of the escalator treads changes from ascending to descending at the top floor, and from descending to ascending at the bottom floor. This permits continuous transportation of the riders to a plurality of floors of varying ceiling heights. At each floor the treads travel horizontally for a short distance allowing time for riders to step off and then walk halfway around the tower to step back on for a return trip. Riders may enter or exit at the bottom floor, at the top floor, or at any intermediate floor. At all intermediate floors they may also continue standing on the treads and ride to the next floor.

### BRIEF DESCRIPTION OF THE DRAWINGS

FIG. 1 is an isometric view of the duo spiral escalator illustrating the delivery locations of passengers to three floors.

FIG. 2 is the same view as FIG. 1 without the floors to better show the escalator treads.

FIG. 3 is an isometric view of the escalator illustrating the possibility of four floors.

FIG. 4 shows the escalator with guard rails and delivery locations on three floors.

FIG. 5 is the same view as FIG. 4 without the center tower, the floors, and the guard rails.

FIG. 6 focuses attention on the tread movement at the top floor. It shows an unfolded (straightened) side view of the escalator treads rolling on tracks as seen from the axis of the tower. Only the outer track for the front wheel is shown. The treads ascend to the top floor, roll under and behind a wall, move up to the ceiling as they circle halfway around the tower along its outer edge, are lowered from the ceiling to the floor, roll out from under the other wall, and then descend to the next floor. The two walls are on opposite sides of the tower approximately 180 degrees apart.

FIG. 7 shows the three dimensional rendering of the unfolded tread movement of FIG. 6.

FIG. 8 shifts attention to the bottom floor. It shows an unfolded (straightened) side view of the escalator treads rolling on tracks as seen from the axis of the tower. Only the outer track for the front wheel is shown. The treads descend to the bottom floor, move horizontally, drop below the floor, circle halfway around the base of the tower along its outer edge, are raised vertically, emerge from the floor, move horizontally, and then ascend to the next floor.

FIG. 9 shows the three dimensional rendering of the unfolded tread movement of FIG. 8.

### DETAILED DESCRIPTIONS OF THE DRAWINGS

FIG. 1 is an isometric view of the escalator including floors. It demonstrates that riders can be received and delivered at a plurality of floors, three in this figure. At intermediate floors 12 riders may step off, step on, or continue riding to the next floor. A plurality of ceiling heights can also be achieved, as shown by 2 and 3. Note that all floors have a common center and circumference, 1. In all nine figures, when the escalator is in motion, the parts that are going up are labeled 4 and the parts that are going down are labeled 5. The top floor in FIG. 1 shows a wall 7 with the treads passing underneath requiring riders to step off 9. The treads then follow a path that takes them up to a plateau 11 near the ceiling of the top floor. They follow the curvature of the central tower about halfway around, descend vertically 6 back down to floor level, and then come out on the back side as revealed in FIG. 4 where there is another wall 8. The escalator treads are now moving in the opposite direction around the tower as they were when coming up. They move horizontally for a short distance as shown in FIG. 4 allowing riders to step on 10 the escalator just before it descends.

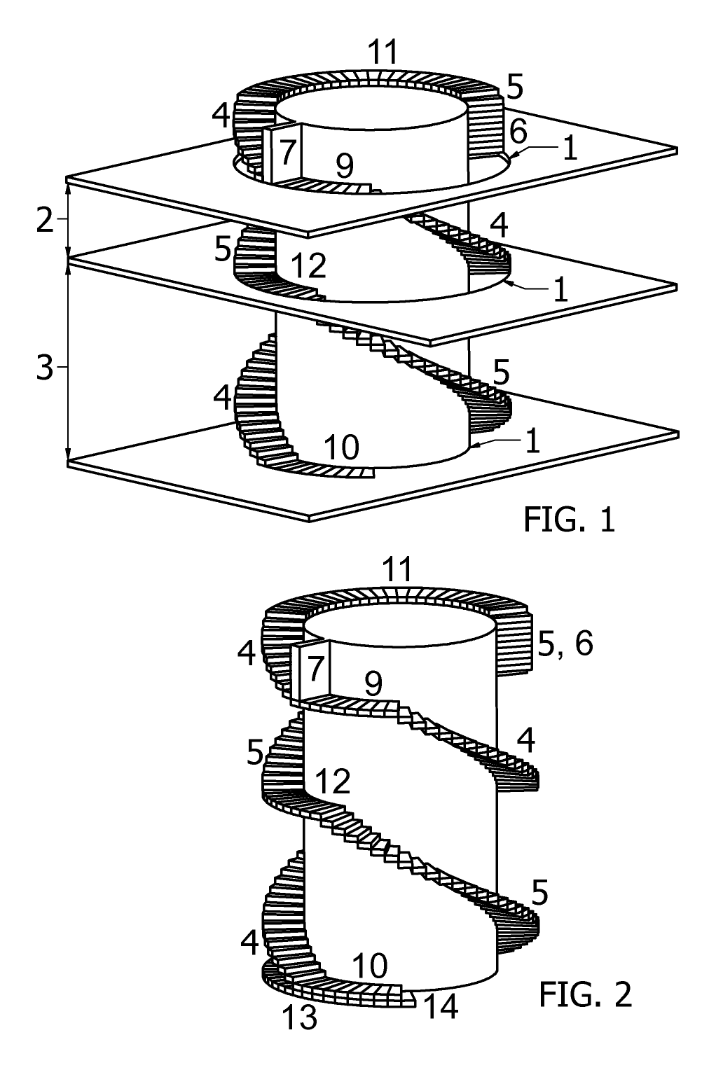

FIG. 2 is the same as FIG. 1 but with the floors removed for clarity. It shows the ascending treads 4 and descending treads 5 becoming level at each floor (9, 10, and 12) for passengers to enter and exit the escalator on opposite sides of the tower. At the bottom floor, the treads coming around from the back on the left side of the tower are just below the floor level 13. After traveling halfway around the tower, the treads come back up to the floor level 14 and reverse direction. Then they move horizontally 10 for a short distance to allow passengers to step onto the escalator just before it goes up 4.

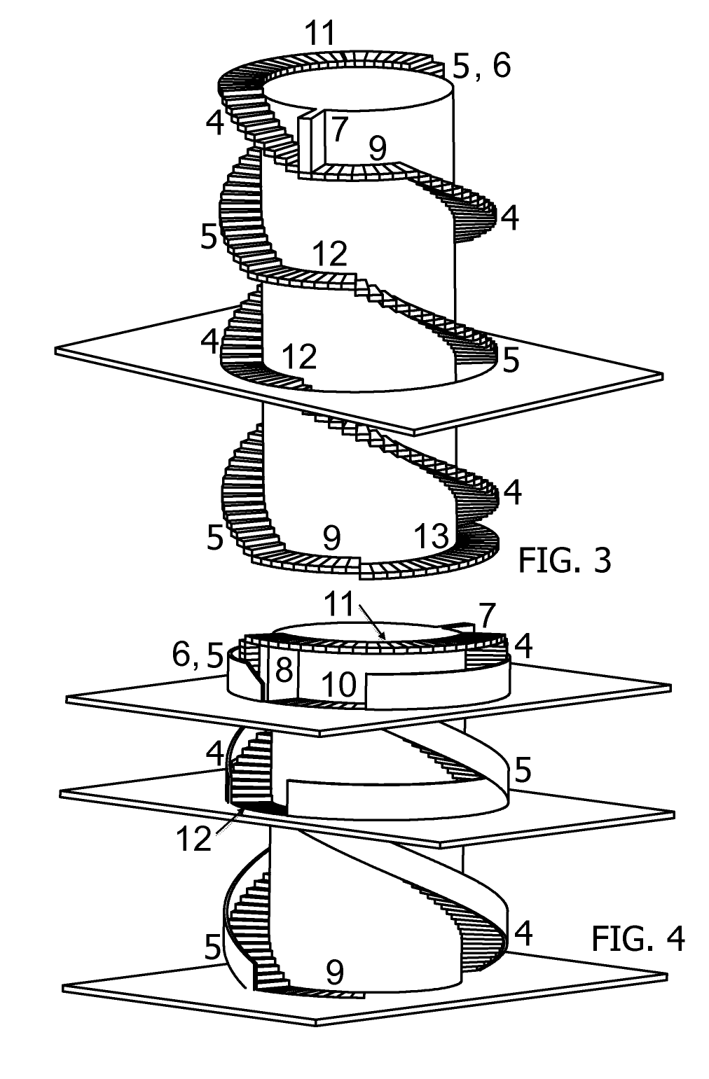

FIG. 3 shows another isometric view. There are a total of four floors here with the plane drawn to illustrate the second floor. It is useful to compare FIG. 2 to FIG. 3 at the bottom floor to gain a more complete understanding of the transition from descending to ascending as the treads travel half way around the tower below the floor in a horizontal plane 13.

FIG. 4 is an isometric view showing three floors along with the necessary guard rails.

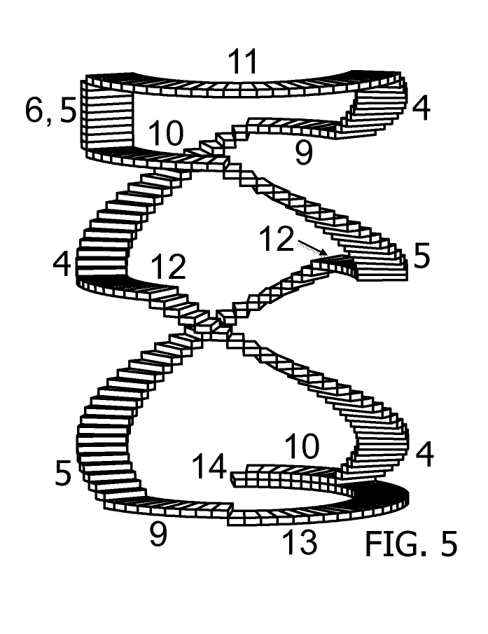

FIG. 5 is the same view as FIG. 4 with the center tower, the floors, and the guard rails removed for clarity. This view reveals the entire continuous tread path.

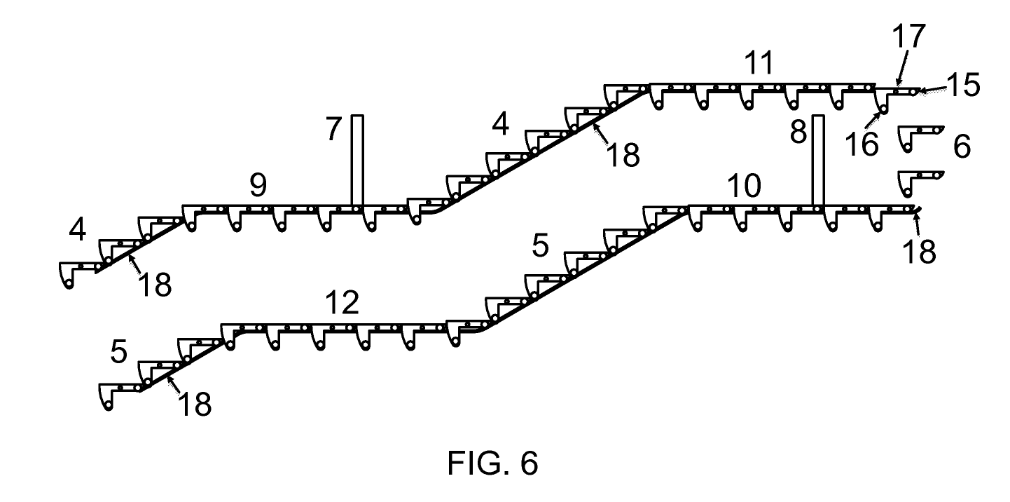

FIG. 6 focuses attention on the tread movement at the top floor. It shows an unfolded (straightened) side view of the escalator treads rolling on tracks as seen from the axis of the tower. Only the outer track 18 for the front wheels is shown. Each tread has two front wheels 15, two back wheels 16, and a center support rod 17. The treads are pulled along the tracks by means of chains attached to the center support rod. The treads ascend 4 to the top floor, move horizontally as riders step off 9, roll under and behind a wall 7, move up to the ceiling as they circle halfway around the inside of the tower along its outer edge 11, are lowered from the ceiling to the floor 6, roll out from under the other wall 8, move horizontally as riders step on 10, descend 5 to an intermediate floor 12, move horizontally, and descend 5 to the next floor. Walls 7 and 8 are on opposite sides of the tower approximately 180 degrees apart. At the intermediate level 12, riders may step off, step on, or continue riding to the next floor.

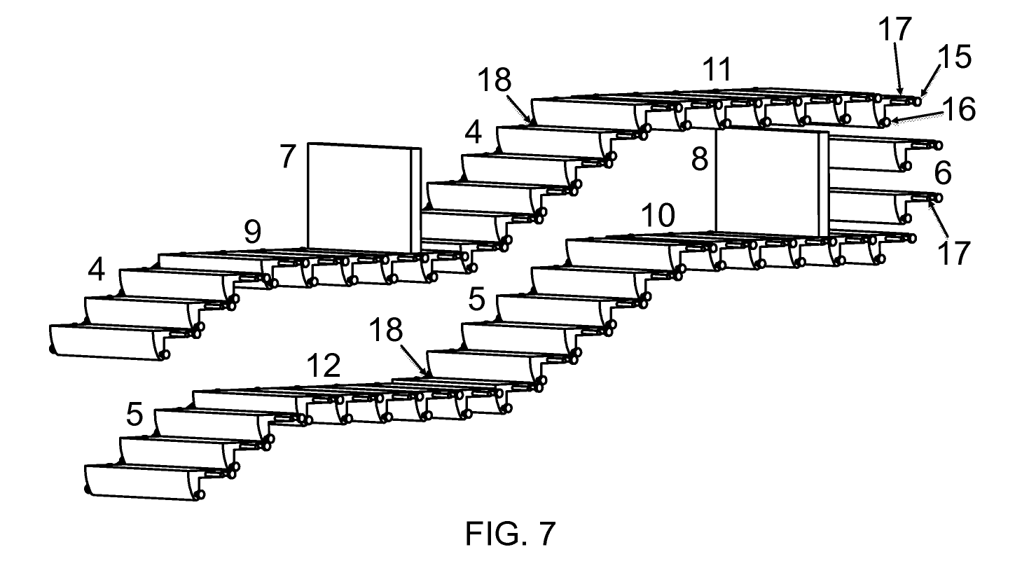

FIG. 7 shows the three dimensional rendering of the unfolded tread movement of FIG. 6. All of the detailed description of FIG. 6 applies here. This view again shows the front wheels 15, back wheels 16, and center rod 17 of each tread.

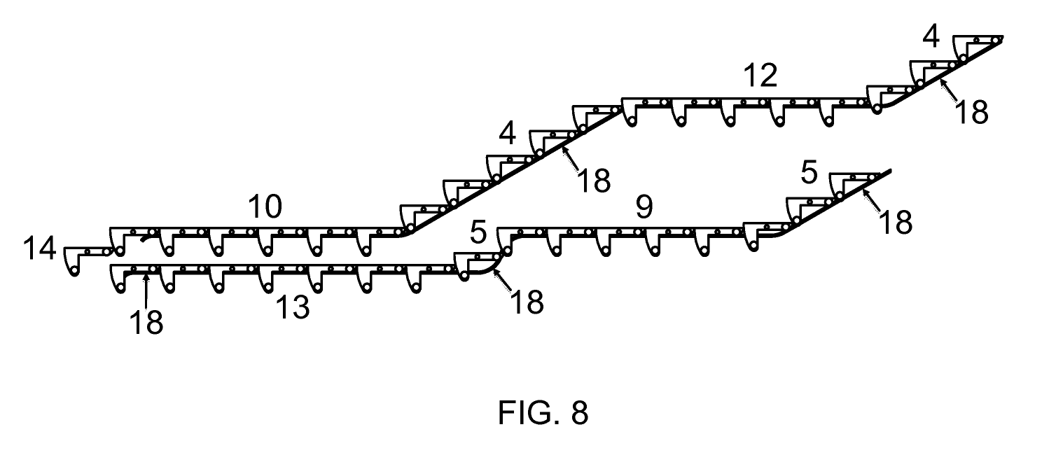

FIG. 8 shifts attention to the bottom floor. It shows an unfolded (straightened) side view of the escalator treads rolling on tracks 18 as seen from the axis of the tower. The treads descend 5 to the bottom floor, move horizontally as riders step off 9, drop below the floor 5, circle halfway around the base of the tower along its outer edge 13, are raised vertically 14, emerge from the floor, move horizontally as riders step on 10, ascend 4 to an intermediate floor 12, move horizontally, and ascend 4 to the next floor.

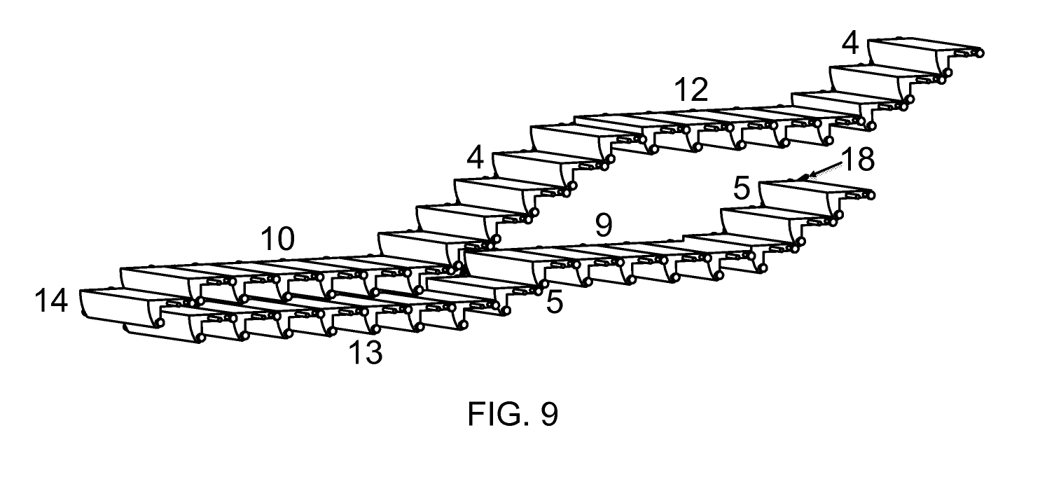

FIG. 9 shows the three dimensional rendering of the unfolded tread movement of FIG. 8. All of the detailed description of FIG. 8 applies here.

1. A duo spiral escalator with direct return, which simultaneously moves all of the connected escalator treads on multiple floors by means of tracks and chains around the outside of a cylindrical tower as the treads sequentially ascend from the bottom floor, move horizontally to permit riders to step off and on at intermediate floors, ascend to the top floor, allow riders to step off at the top floor, disappear behind a wall, ascend to the ceiling and circle halfway around the tower, descend vertically to the floor level, emerge beneath another wall, allow riders to step on at the top floor, descend, move horizontally to permit riders to step off and on at intermediate floors, descend to the bottom floor, allow riders to step off at the bottom floor, disappear below the floor as they descend and circle halfway around the base of the tower, rise vertically to emerge from the floor, and allow riders to step on at the bottom floor, thus completing the cycle.

2. The duo spiral escalator of claim 1, permits service to a plurality of floors such that the riders may remain standing on the treads at all intermediate floors to continue on without stepping off to walk to a separate escalator.

3. The duo spiral escalator of claim 1, permits a plurality of ceiling heights between floors.

4. The duo spiral escalator of claim 1, permits all escalator treads to move between floors with riders aboard in contrast with other escalators wherein half of the treads are empty as they travel back underneath.

5. The duo spiral escalator of claim 1, permits entering and exiting at each floor on opposite sides of the escalator tower.

6. The duo spiral escalator of claim 1, permits both ascending and descending stair treads to be in one central structure with a common center and a common diameter.

7. The duo spiral escalator of claim 1, permits either an open structure for maximum observation and aesthetics or a solid interior enclosed tower for economy.

8. (canceled)

9. The duo spiral escalator of claim 1, minimizes mechanical designs and operations due to common and consistent diameters up and down the tower.

10. The duo spiral escalator of claim 1, permits minimal use of horizontal space due to the small footprint of a single tower structure.
